(19) United States
(12) Patent Application Publication
(10) Pub. No.: US 2006/0040130 A1
(43) Pub. Date: Feb. 23, 2006

(54) Electroluminescent device

(76) Inventor: Poopathy Kathirgamanathan, North Harrow (GB)

Correspondence Address: Andover IP Law, Suite 300, 44 Park Street, Andover, MA, 01810, US

(21) Appl. No.: 10/506,523

(22) PCT Filed: Mar. 5, 2003
(86) PCT No.: PCT/GB03/00922

§ 371 Date: Sep. 3, 2004

(30) Foreign Application Priority Data
Mar. 6, 2002 (GB) 0205212.4

(51) Int. Cl. B32B 19/00

(52) U.S. Cl. 428/690

(57) ABSTRACT

According to the invention there is provided an electroluminescent device comprising in sequence, an anode a layer of an electroluminescent material of general formula L(α)ₐM where M is a rare earth, lanthanide or an actinide, Lα is a organic complex and n is the valence state of M and a cathode, in which the layer of an electroluminescent material includes a fluorescent dye.

The present invention relates to electroluminescent devices and displays.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

With organic light emitting polymers it is not possible to obtain pure colours, they are expensive to make and have a relatively low efficiency.

Patent application WO98/58037 describes a range of lanthanide complexes which can be used in electroluminescent devices which have improved properties and give better results. Patent Applications PCT/GB99/01773, PCT/GB99/03619, PCT/GB99/04030, PCT/GB99/04024, PCT/GB99/04028, PCT/GB00/00268 describe electroluminescent complexes, structures and devices using rare earth chelates.

In order to modify the light emitted a fluorescent dye can be incorporated in the electroluminescent layer or in the electron transmitting layer.

According to the invention there is provided an electroluminescent device comprising in sequence, an anode, a layer of an electroluminescent material of general formula (Lα)ₙM where M is a rare earth, lanthanide or an actinide, Lα is an organic complex and n is the valence state of M and a cathode, in which the layer of an electroluminescent material includes a fluorescent dye.

The electroluminescent compounds which can be used as the electroluminescent materials in the present invention are of general formula (Lα)ₙM where M is a rare earth, lanthanide or an actinide, Lα is an organic complex and n is the valence state of M.

Preferred electroluminescent compounds which can be used in the present invention are of formula 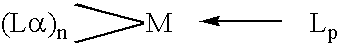
where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example (L₁)(L₂)(L₃)(L . . . )M (Lp) where M is a rare earth, transition metal, lanthanide or an actinide and (L₁)(L₂)(L₃)(L . . . ) are the same or different organic complexes and (Lp) is a neutral ligand. The total charge of the ligands (L₁)(L₂)(L₃)(L . . . ) is equal to the valence state of the metal M. Where there are 3 groups Lα which corresponds to the m valence state of M the complex has the formula (L₁)(L₂)(L₃)M (Lp) and the different groups (L₁)(L₂)(L₃) may be the same or different

Lp can be monodentate, bidentate or polydentate and there can be one or more ligands Lp.

Preferably M is metal ion having an unfilled inner shell and the preferred metals are selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III), Er(III) and more preferably Eu(III), Tb(III), Dy(III), Gd (IlI).

Further electroluminescent compounds which can be used in the present invention are of general formula (Lα)ₙM₁M₂ where M₁ is the same as M above, M₂ is a non rare earth metal, Lα is a as above and n is the combined valence state of M₁ and M₂. The complex can also comprise one or more neutral ligands Lp so the complex has the general formula (Lα)ₙ M₁ M₂ (Lp), where Lp is as above. The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium. titanium, vanadium, zirconium, tantulum, molybdenum, rhodium, iridium, titanium, niobium, scandium, yttrium.

For example (L₁)(L₂)(L₃)(L . . . )M (Lp) where M is a rare earth, transition metal, lanthanide or an actinide and (L₁)(L₂)(L₃)(L . . . ) and (Lp) are the same or different organic complexes.

Further organometallic complexes which can be used in the present invention are binuclear, trinuclear and polynuclear organometallic complexes e.g. of formula
(Lm)ₓM₁←M₂(Ln)_{y} e.g.

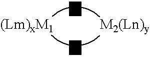

where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula 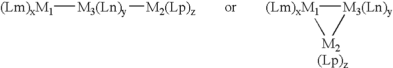
where M₁, M₂ and M₃ are the same or different rare earth metals and Lm, Ln and Lp are organic ligands Lα and x is the valence state of M₁, y is the valence state of M₂ and z is the valence state of M₃. Lp can be the same as Lm and Ln or different.

The rare earth metals and the non rare earth metals can be joined together by a metal to metal bond and/or via an intermediate bridging atom, ligand or molecular group. For example the metals can be linked by bridging ligands e.g. 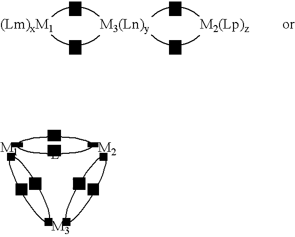
where L is a bridging ligand

By polynuclear is meant there are more than three metals joined by metal to metal bonds and/or via intermediate ligands 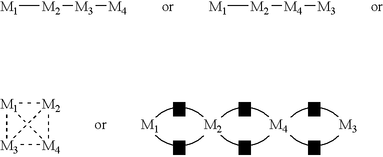
where M₁, M₂, M₃ and M₄ are rare earth metals and L is a bridging ligand.

The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals e.g. manganese, iron, ruthenium, osmium, cobalt, nickel, palladium, platinum, cadmium, chromium. titanium, vanadium, zirconium, tantulum, molybdenum, rhodium, iridium, titanium, niobium, scandium, yttrium etc.

Preferably Lα is selected from β diketones such as those of formulae 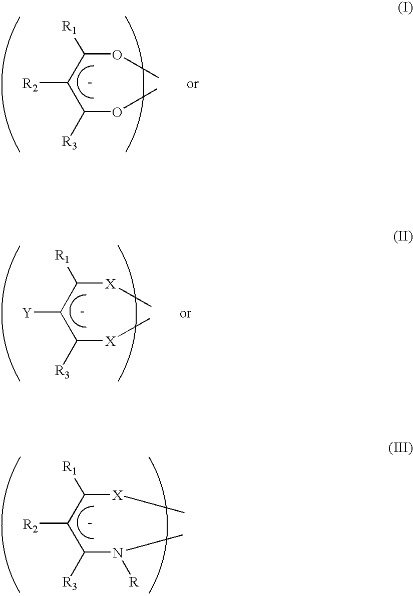
where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups L may also be the same or different charged groups such as carboxylate groups so that the group L₁ can be as defined above and the groups L₂, L₃ . . . can be charged groups such as 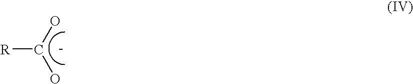
where R is R₁ as defined above or the groups L₁, L₂ can be as defined above and L₃ . . . etc. are other charged groups.

R₁, R₂ and R₃ can also be 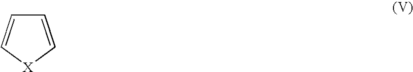
where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifiuoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups L may be the same or different ligands of formulae 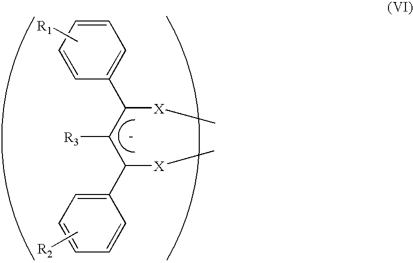
where X is O, S, or Se and R₁ R₂ and R₃ are as above

The different groups L may be the same or different quinolate derivatives such as 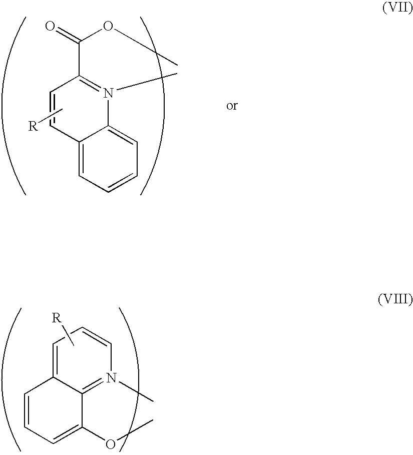
where R is hydrocarbyl, aliphatic, aromatic or heterocyclic carboxy, aryloxy, hydroxy or alkoxy e.g. the 8 hydroxy quinolate derivatives or 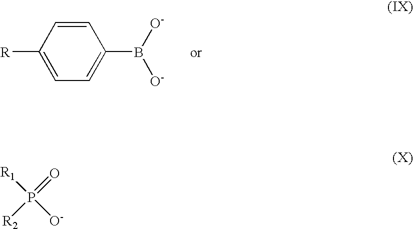
where R, R₁, and R₂ are as above or are H or F e.g. R₁ and R₂ are alkyl or alkoxy groups

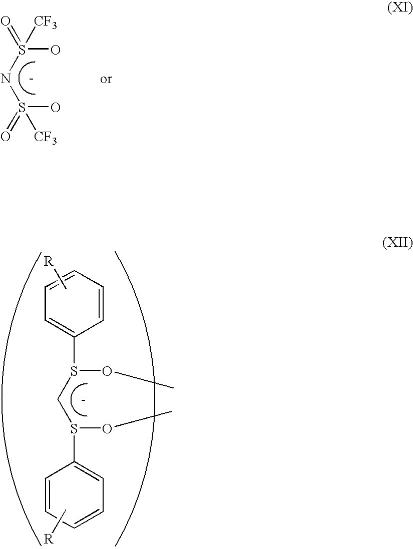

As stated above the different groups L may also be the same or different carboxylate groups e.g. 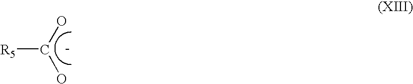
where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or Lα can be 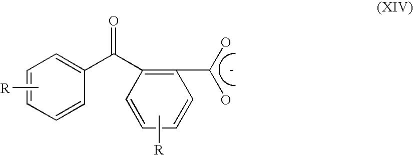
where R is as above e.g. alkyl, allenyl, amino or a fuised ring such as a cyclic or polycyclic ring.

The different groups L may also be

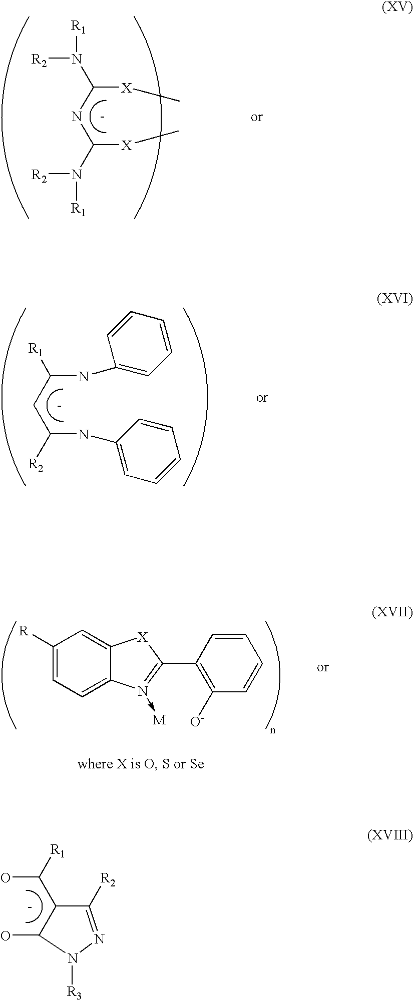

Where R, R₁ and R₂ are as above or

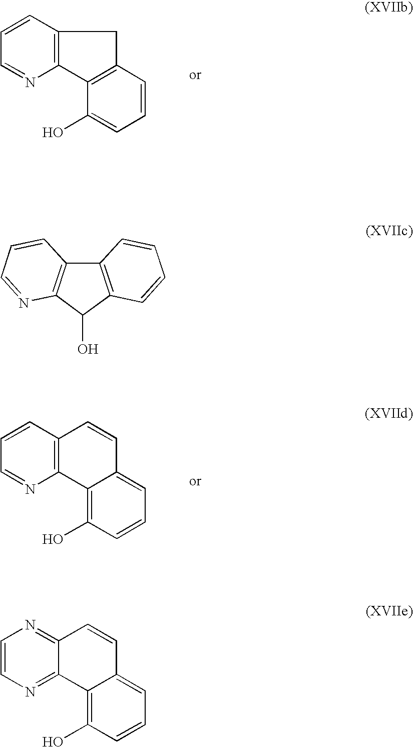

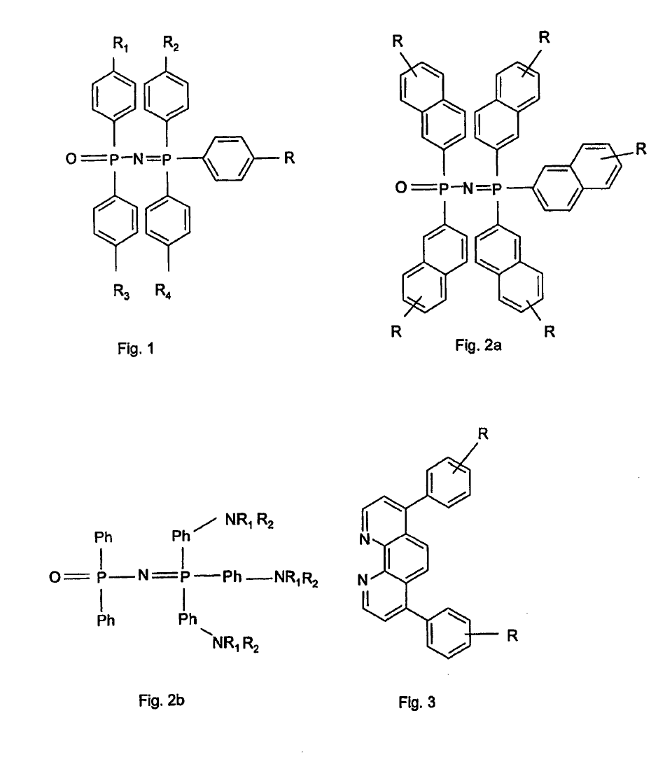

The groups L_{P} can be selected from

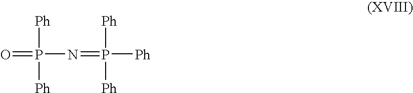

Where each Ph which can be the same or different and can be a phenyl (OPNP) or a substituted phenyl group, other substituted or unsubstituted aromatic group, a substituted of unsubstituted heterocyclic or polycyclic group, a substituted or unsubstituted fuised aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino. Substituted amino etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trffluoryl methyl groups, halogens such as fluorine or thiophenyl groups; R, R₁, R₂, R₃ and R₄ can also form substituted and unsubstituted fuised aromatic, heterocyclic and polycyclic ring structures and can be copolymerisable with a monomer e.g. styrene. R, R₁, R₂, R₃ and R₄ can also be unsaturated alklene groups such as vinyl groups or groups
—C—CH₂═CH₂—R
where R is as above.

Lₚ can also be compounds of formulae 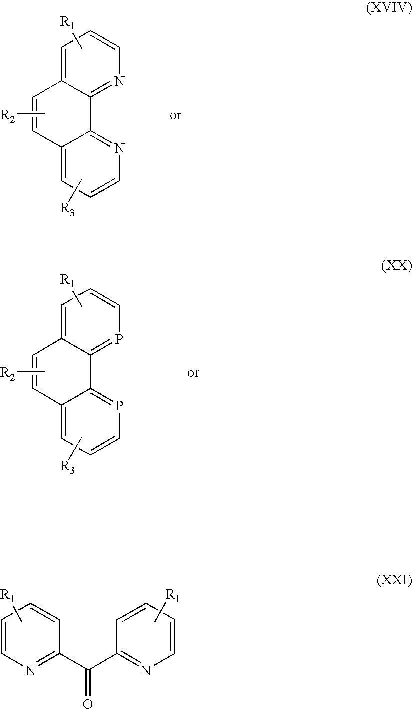
where R₁, R₂ and R₃ are as referred to above, for example bathophen shown in FIG. 3 of the drawings in which R is as above or 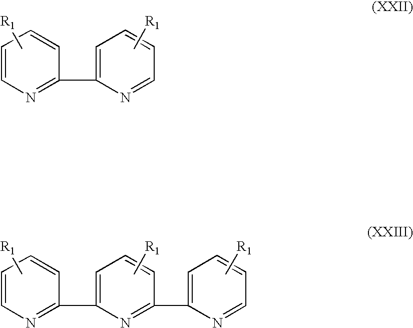
where R₁, R₂ and R₃ are as referred to above.

Lₚ can also be 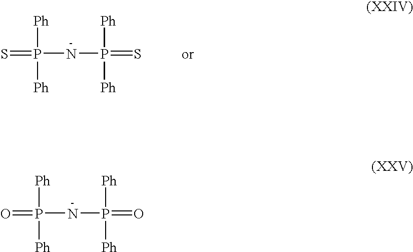
where Ph is as above.

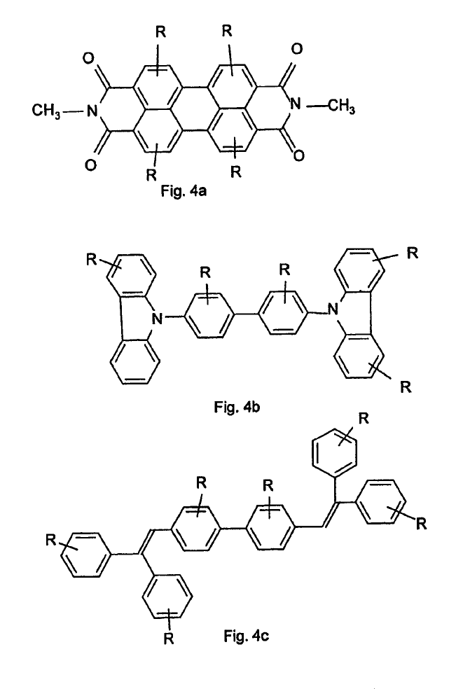

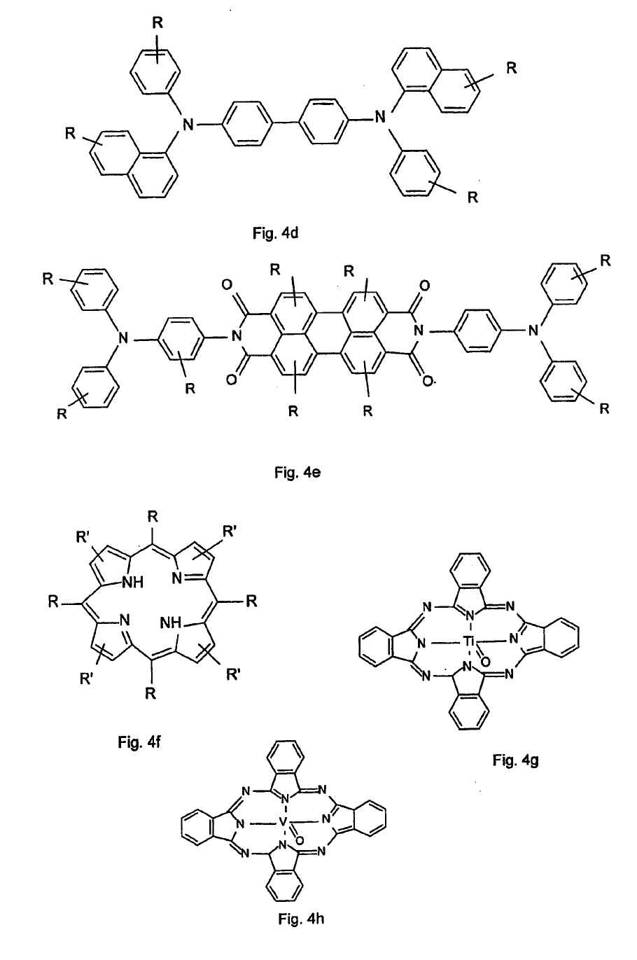

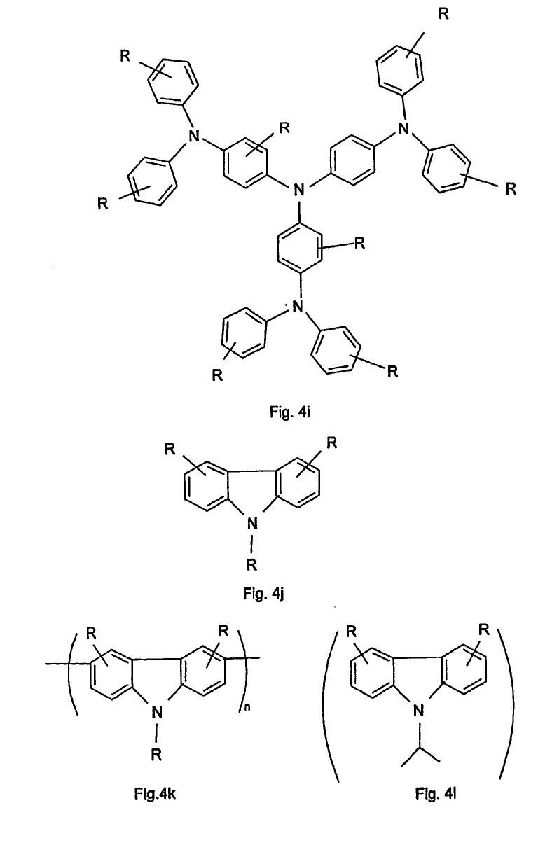

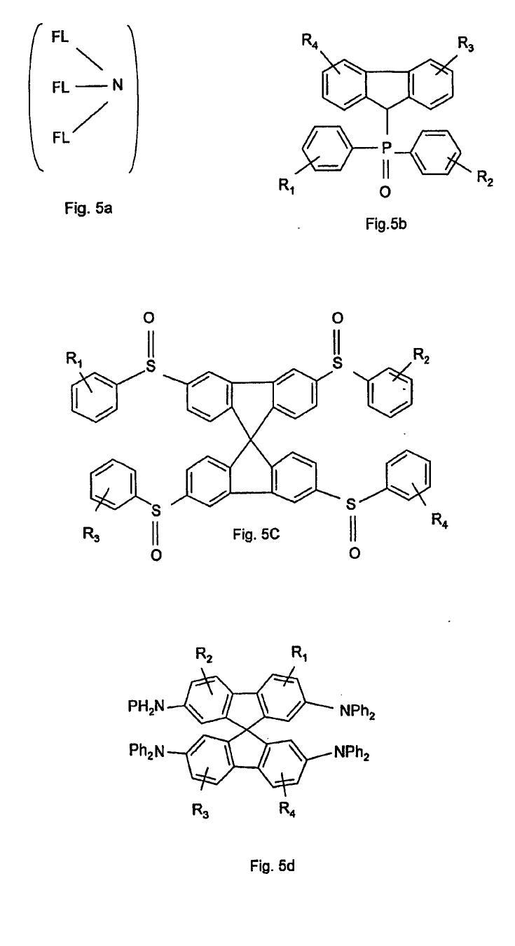

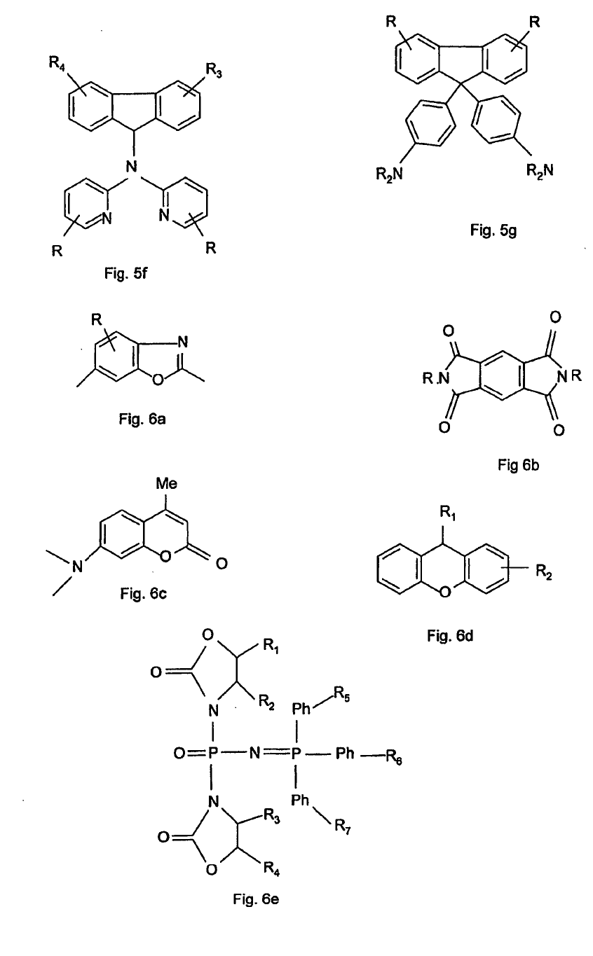

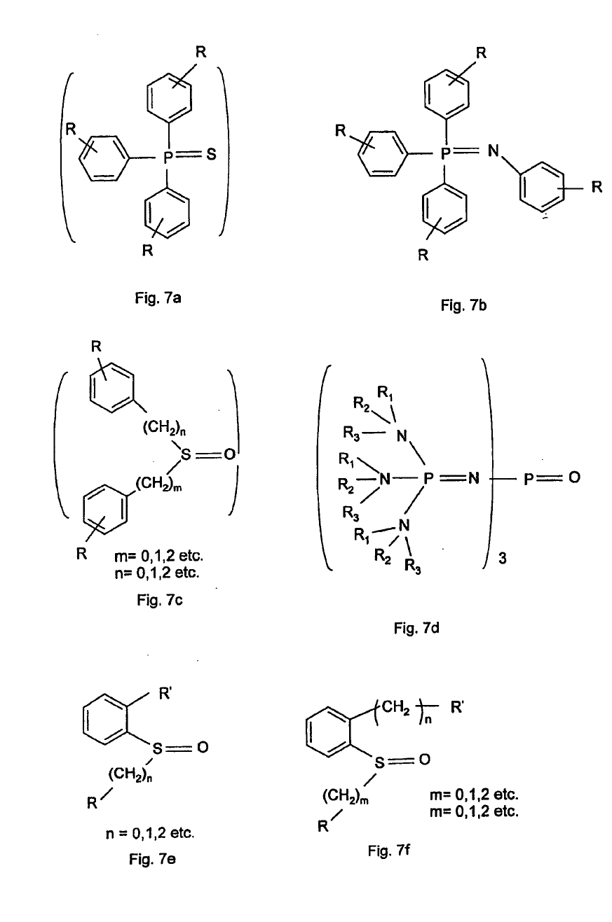

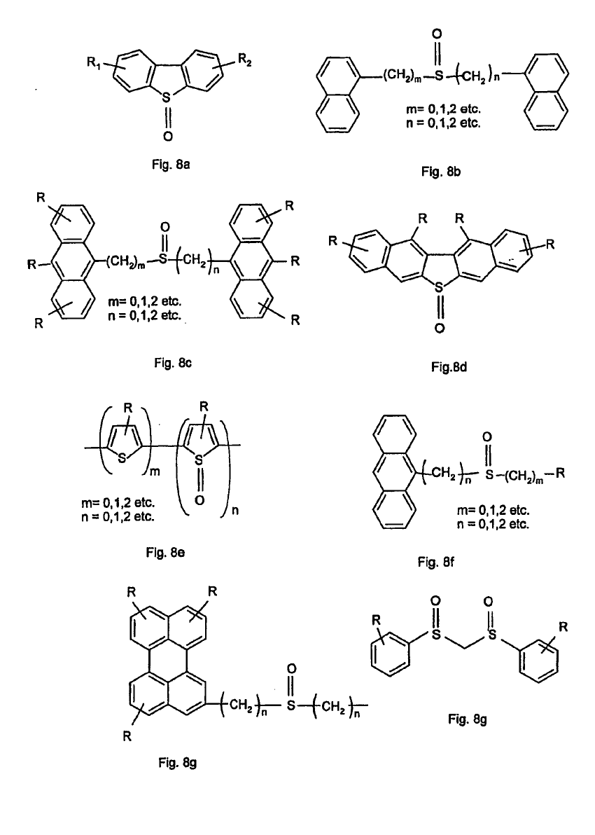

Other examples of Lₚ chelates are as shown in FIG. 4 and fluorene and fluorene derivatives e.g. a shown in FIG. 5 and compounds of formulae as shown as shown in FIGS. 6 to 8.

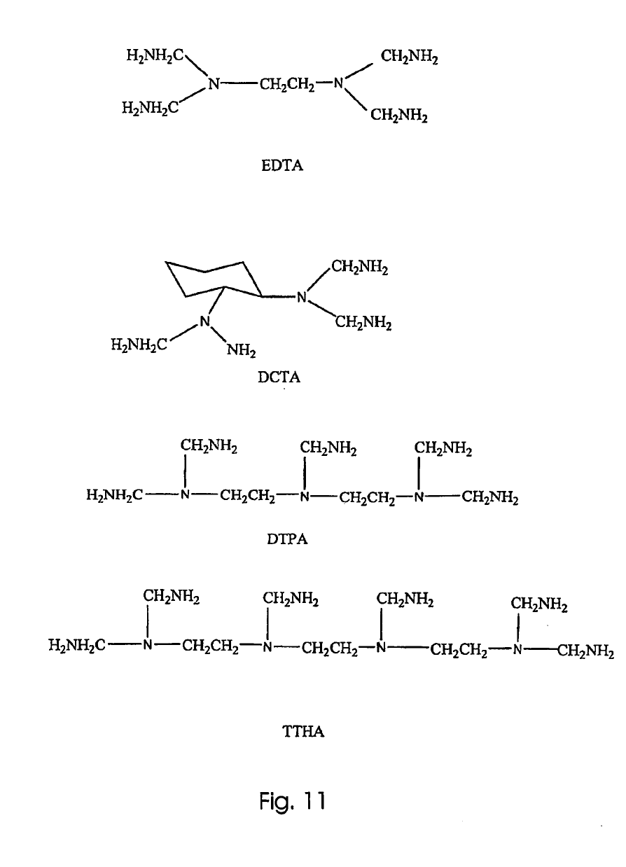

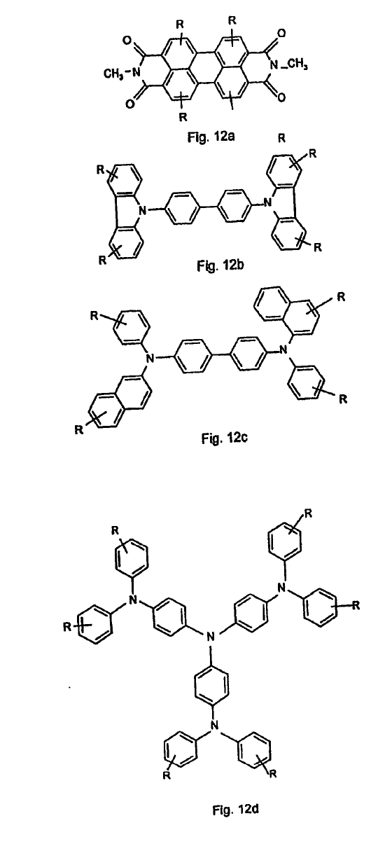

Specific examples of Lα and Lp are tripyridyl and TMHD, and TMMD complexes, α, α′, α″ tripyridyl, crown ethers, cyclans, cryptans phthalocyanans, porphoryins ethylene diamine tetramine (EDTA), DCTA, DTPA and TTHA. Where TMHD is 2,2,6,6-tetramethyl-3,5-heptanedionato and OPNP is diphenylphosphonimide triphenyl phosphorane. The formulae of the polyamines are shown in FIG. 11.

Other electroluminescent materials which can be used include metal quinolates such as lithium quinolate, and non rare earth metal complexes such as aluminium, magnesium, zinc and scandium complexes such as complexes of β-diketones e.g. Tris-(1,3-diphenyl-1-3-propanedione) (DBM) and suitable metal complexes are Al(DBM)₃, Zn(DBM)₂ and Mg(DBM)₂, Sc(DBM)₃ etc.

The first electrode is preferably a transparent substrate such as is a conductive glass or plastic material which acts as the anode, preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate.

The hole transporting material can be an amine complex such as poly (vinylcarbazole), N,N′-diphenyl-N,N′-bis(3-methylphenyl)-1,1′-biphenyl-4,4′-diamine(TPD), an unsubstituted or substituted polymer of an amino substituted aromatic compound, a polyaniline, substituted polyanilines, polytiiophenes, substituted polythiophenes, polysilanes etc. Examples of polyanilines are polymers of 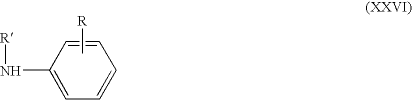
where R is in the ortho- or meta-position and is hydrogen, C1-18 alkyl, C1-6 alkoxy, amino, chloro, bromo, hydroxy or the group

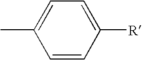

where R is alky or aryl and R′ is hydrogen, C1-6 alkyl or aryl with at least one other monomer of formula I above.

Or the hole transporting material can be a polyaniline, polyanilines which can be used in the present invention have the general formula 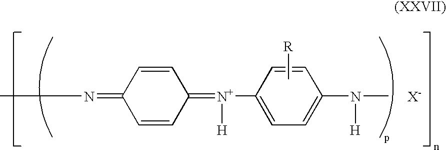
where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate, an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is deprotonated the it can be easily evaporated i.e. the polymer is evaporable.

Preferably evaporable deprotonated polymers of unsubstituted or substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarinid and A. F. Epstein, Faraday Discussions, Chem Soc. 88 P 319 1989.

The conductivity of the polyaniline is dependant on the degree of protonation with the maximum conductivity being when the degree of protonation is between 40 and 60% e.g. about 50% for example.

Preferably the polymer is substantially fully deprotonated

A polyaniline can be formed of octamer units i.e. p is four e.g.

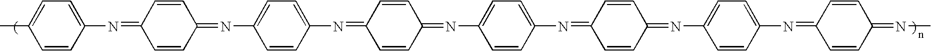

The polyanilines can have conductivities of the order of 1×10⁻¹ Siemen cm⁻¹ or higher.

The aromatic rings can be unsubstituted or substituted e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyarninonapthatenes, polyaminoanthracenes, potyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted e.g. by a group R as defined above.

Other hole transporting materials are conjugated polymer and the conjugated polymers which can be used can be any of the conjugated polymers disclosed or referred to in U.S. Pat. No. 5,807,627, PCT/WO90/13148 and PCT/WO92/03490.

The preferred conjugated polymers are poly(p-phenylenevinylene)-PPV and copolymers including PPV. Other preferred polymers are poly(2,5 dialkoxyphenylene vinylene) such as poly(2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substituents e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as anthracene or naphthlyene ring and the number of vinylene groups in each polyphenylenevinylene moiety can be increased e.g. up to 7 or higher.

The conjugated polymers can be made by the methods disclosed in U.S. Pat. No. 5,807,627, PCT/WO90113148 and PCT/WO92/03490.

The thickness of the hole transporting layer is preferably 20 nm to 200 nm.

The polymers of an amino substituted aromatic compound such as polyanilines referred to above can also be used as buffer layers with or in conjunction with other hole transporting materials.

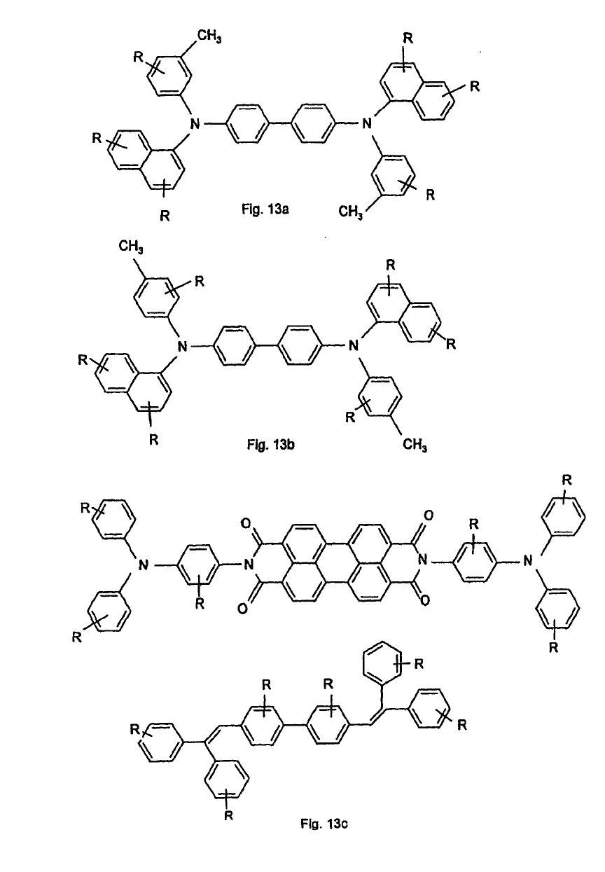

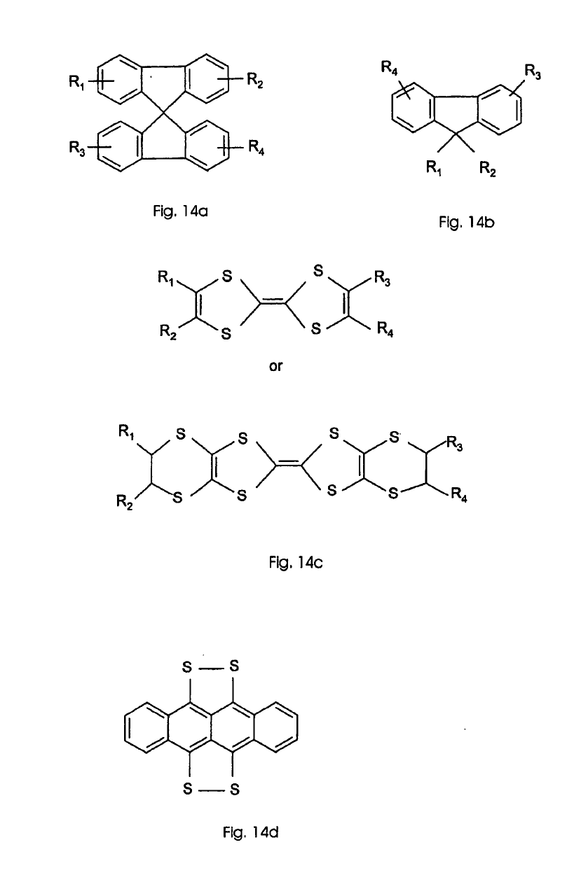

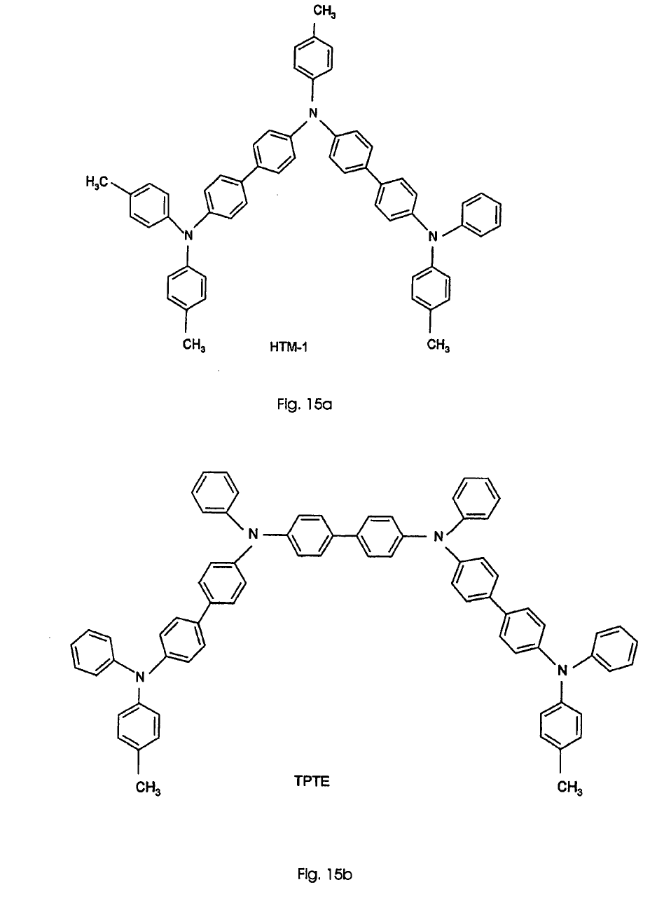

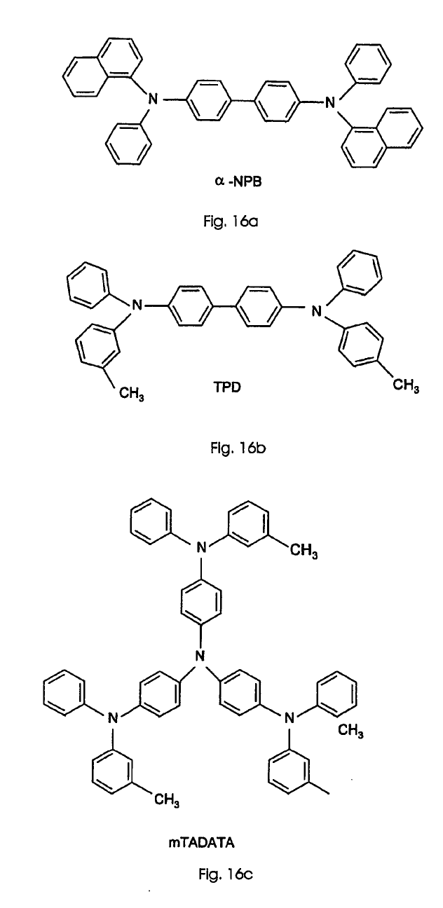

The structural formulae of some other hole trsporting materials are shown in FIGS. 12, 13, 14 15 and 16 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

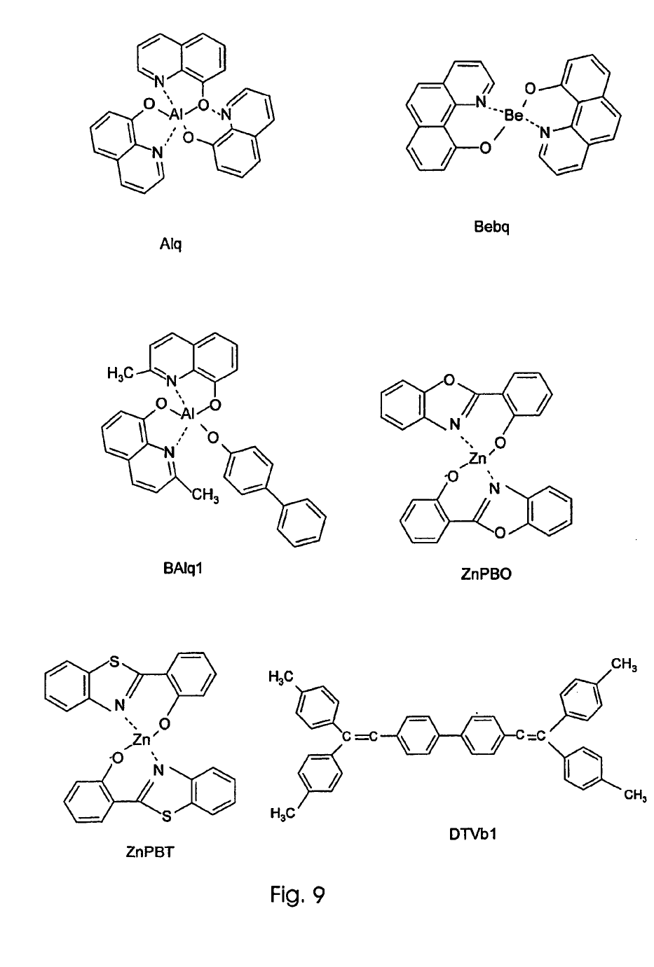

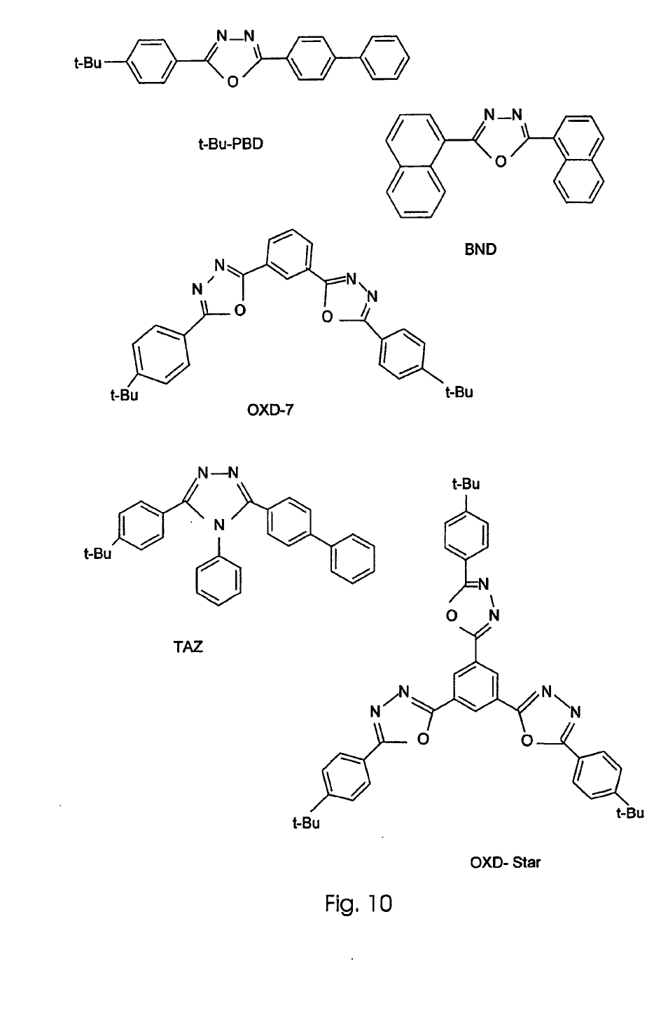

Optionally there is a layer of an electron injecting material between the cathode and the electroluminescent material layer, the electron injecting material is a material which will transport electrons when an electric current is passed through electron injecting materials include a metal complex such as a metal quinolate e.g. an aluminium quinolate, lithium quinolate, a cyano anthracene such as 9,10 dicyano anthracene, cyano substituted aromatic compounds, tetracyanoquinidodimethane a polystyrene sulphonate or a compound with the structural formulae shown in FIGS. 9 and 10 of the drawings in which the phenyl rings can be substituted with substituents R as defined above. Instead of being a separate layer the electron injecting material can be mixed with the electroluminescent material and co-deposited with it.

The second electrode fumctions as the cathode and can be any low work function metal e.g. aluminium, calcium, lithium, silver/magnesium alloys, rare earth metal alloys etc., aluminium is a preferred metal. A metal fluoride such as an allali metal, rare earth metal or their alloys can be used as the second electrode for example by having a metal fluoride layer formed on a metal.

Optionally the hole transporting material can be mixed with the electroluminescent material and co-deposited with it.

The hole transporting materials, the electroluminescent material and the electron injecting materials can be mixed together to form one layer, which simplifies the construction.

The display of the invention may be monochromatic or polychromatic. Electroluminescent rare earth chelate compounds are known which will emit a range of colours e.g. red, green, and blue light and white light and examples are disclosed in Patent Applications WO98/58037 PCT/GB98/01773, PCT/GB99/03619, PCT/GB99/04030, PCT/GB99/04024, PCTVGB99/04028, PCT/GB00/00268 and can be used to form OLEDs emitting those colours. Thus, a full colour display can be formed by arranging three individual backplanes, each emitting a different primary monochrome colour, on different sides of an optical system, from another side of which a combined colour image can be viewed. Alternatively, rare earth chelate electroluminescent compounds emitting different colours can be fabricated so that adjacent diode pixels in groups of three neighbouring pixels produce red, green and blue light. In a flirter alternative, field sequential colour filters can be fitted to a white light emitting display.

Either or both electrodes can be formed of silicon and the electroluminescent material and intervening layers of a hole transporting and electron transporting materials can be formed as pixels on the silicon substrate. Preferably each pixel comprises at least one layer of a rare earth chelate electroluminescent material and an (at least semi-) transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode the cathode can be formed of a transparent electrode which has a suitable work fumction, for example by a indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers, for example a higher work function metal such as aluminium deposited on the substrate and a lower work fuiction metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

As described in WO00/60669 the brightness of light emitted from each pixel is preferably controllable in an analogue manner by adjusting the voltage or current applied by the matrix circuitry or by inputting a digital signal which is converted to an analogue signal in each pixel circuit. The substrate preferably also provides data drivers, data converters and scan drivers for processing information to address the array of pixels so as to create images. When an electroluminescent material is used which emits light of a different colour depending on the applied voltage the colour of each pixel can be controlled by the matrix circuitry.

In one embodiment, each pixel is controlled by a switch comprising a voltage controlled element and a variable resistance element, both of which are conveniently formed by metal-oxide-semiconductor field effect transistors (MOSFETs) or by an active matrix transistor.

U.S. Pat. No. 4,769,292 disclose a range of fluorescent dyes which can be used in luminescent devices in which the electroluminescent material is aluminium quinolate or an aluminium quinolate derivative.

We have now discovered that fluorescent dyes can be added to electroluminescent complexes of general formula (Lα)ₙM where M is a rare earth, lanthanide or an actinide, Lα is an organic complex and n is the valence state of M.

As explained in U.S. Pat. No. 4,769,292 the light is emitted in the electroluminescent material layer in response to the injection and combination of holes in the layer. If a fluorescent material is added to the electroluminescent the colour of the emitted light can be varied. In theory, if an electroluminescent host material and a fluorescent material could be found for blending which have exactly the same affinity for hole-electron recombination each material should emit light upon injection of holes and electrons in the luminescent zone. The perceived hue of light emission would be the visual integration of both emissions. Since imposing such a balance of host and fluorescent materials is highly limiting, it is preferred to choose the fluorescent material so that it provides the favored sites for light emission. When only a small proportion of fluorescent material providing favored sites for light emission is present, peak intensity wavelength emissions typical of the host material can be entirely eliminated in favor of a new peak intensity wavelength emission attributable to the fluorescent material. While the minimum proportion of fluorescent material sufficient to achieve this effect varies by the specific choice of host and fluorescent materials, in no instance is it necessary to employ more than about 10 mole percent fluorescent material, based on moles of host material and seldom is it necessary to employ more than 1 mole percent of the fluorescent material. On the other hand, for any host material capable of emitting light in the absence of fluorescent material, limiting the fluorescent material present to extremely small amounts, typically less than about 10⁻³ mole percent, based on host material, can result in retaining emission at wavelengths characteristic of the host material. Thus, by choosing the proportion of a fluorescent material capable of providing favored sites for light emission, either a full or partial shifting of emission wavelengths can be realized. This allows the spectral emissions of the EL devices of this invention to be selected and balanced to suit the application to be served.

Choosing fluorescent materials capable of providing favored sites for light emission necessarily involves relating the properties of the fluorescent material to those of the host material. The host material can be viewed as a collector for injected holes and electrons with the fluorescent material providing the molecular sites for light emission. One important relationship for choosing a fluorescent material capable of modifying the hue of light emission when present in a host material is a comparison of the reduction potentials of the two materials. The fluorescent materials demonstrated to shift the wavelength of light emission have exhibited a less negative reduction potential than that of the host material.

Reduction potentials, measured in electron volts, have been widely reported in the literature along with varied techniques for their measurement. Since it is a comparison of reduction potentials rather than their absolute values which is desired, it is apparent that any accepted technique for reduction potential measurement can be employed, provided both the fluorescent and host material reduction potentials are similarly measured. A preferred oxidation and reduction potential measurement techniques is reported by R. J. Cox, Photographic Sensitivity, Academic Press, 1973, Chapter 15.

A second important relationship for choosing a fluorescent material capable of modifying the hue of light emission when present in a host material is a comparison of the bandgap potentials of the two materials. The fluorescent materials demonstrated to shift the wavelength of light emission have exhibited a lower bandgap potential than that of the host material. The bandgap potential of a molecule is taken as the potential difference in electron volts (eV) separating its ground state and first singlet state. Bandgap potentials and techniques for their measurement have been widely reported in the literature. The bandgap potentials herein reported are those measured in electron volts (eV) at an absorption wavelength which is bathochromic to the absorption peak and of a magnitude one tenth that of the magnitude of the absorption peak. Since it is a comparison of bandgap potentials rather than their absolute values which is desired, it is apparent that any accepted technique for bandgap measurement can be employed, provided both the fluorescent and host material band gaps are similarly measured.

One illustrative measurement technique is disclosed by F. Gutman and L. E. Lyons, Organic Semiconductors, Wiley, 1967, Chapter 5. Where a host material is chosen which is itself capable of emitting light in the absence of the fluorescent material, it has been observed that suppression of light emission at the wavelengths of emission characteristics of the host material alone and enhancement of emission at wavelengths characteristic of the fluorescent material occurs when spectral coupling of the host and fluorescent materials is achieved. By spectral coupling it is meant that an overlap exists between the wavelengths of emission characteristic of the host material alone and the wavelengths of light absorption of the fluorescent material in the absence of the host material. Optimal spectral coupling occurs when the maximum emission of the host material alone substantially matches within ±25 nm the maximum absorption of the fluorescent material alone.

In practice advantageous spectral coupling can occur with peak emission and absorption wavelengths differing by up to 100 nm or more, depending on the width of the peaks and their hypsochromic and bathochromic slopes. Where less than optimum spectral coupling between the host and fluorescent materials is contemplated, a bathochromic as compared to a hypsochromic displacement of the fluorescent material produces more efficient results.

Useful fluorescent materials are those capable of being blended with the host material and fabricated into thin films satisfying the thickness ranges described above forming the luminescent zones of the EL devices of this invention. While crystalline host materials do not lend themselves to thin film formation, the limited amounts of fluorescent materials present in the host materials permits the use of fluorescent materials which are alone incapable of thin film formation.

Preferred fluorescent materials are those which form a common phase with the host material.

Fluorescent dyes constitute a preferred class of fluorescent materials, since dyes lend themselves to molecular level distribution in the host material. Although any convenient technique for dispersing the fluorescent dyes in the host materials can be undertaken, preferred fluorescent dyes are those which can be vacuum vapour deposited along with the host materials.

Assuming other criteria, noted above, are satisfied, fluorescent laser dyes are recognized to be particularly useful fluorescent materials for use in the organic EL devices of this invention. One preferred class of fluorescent dyes are fluorescent coumarin dyes. Among specifically preferred fluorescent coumarin dyes as described in U.S. Pat. No. 4,769,292 the contents of which are hereby incorporated by reference.

Another preferred class of fluorescent dyes are fluorescent 4-dicyanomethylene-4H-pyrans and 4-dicyanomethylene-4H-thiopyrans, hereinafter referred to as fluorescent dicyanomethylenepyran and thiopyran dyes the preferred fluorescent dyes of this class are specified in U.S. Pat. No. 4,769,292. Useful fluorescent dyes can also be selected from among known polymethine dyes, which include the cyanines, merocyanines, complex cyanines and merocyanines (i.e., tri-, tetra and poly-nuclear cyanines and merocyanines}, oxonols, hemioxonols, styryls, merostyryls, and streptocyanines.

The cyanine dyes include, joined by a methine linkage, two basic heterocyclic nuclei, such as azolium or azinium nuclei, for example, those derived from pyridinium, quinolinium, isoquinolinium, oxazolium, thiazolium, selenazolium, indazolium, pyrazolium, pyrrolium, indoliurn, 3H-indolium, imidazolium, oxadiazolium, thiadioxazolium, benzoxazolium, benzothiazolium, benzoselenazolium, benzotellurazolium, benzimidazolium, 3H or 1H-benzoindolium, naphthoxazolium, naphthothiazolium, naphthoselenazolium, naphthotellurazolium, carbazolium, pyrrolopyridinium, phenanthrothiazolium, and acenaphthothiazolium quaternary salts.

Cyanine dyes can contain two heterocyclic nuclei joined by a methine linkage containing an uneven number of methine groups or can contain a heterocyclic nucleus joined by a methine linkage containing an even number of methine groups.

The greater the number of the methine groups linking nuclei in the polymethine dyes in general and the cyanine dyes in particular the longer the absorption wavelengths of the dyes. For example, dicarbocyanine dyes (cyanine dyes containing five methine groups linking two basic heterocyclic nuclei) exhibit longer absorption wavelengths than carbocyanine dyes (cyanine dyes containing three methine groups linking two basic heterocyclic nuclei) which in turn exhibit longer absorption wavelengths than simple cyanine dyes (cyanine dyes containing a single methine group linking two basic heterocyclic nuclei). Carbocyanine and dicarbocyanine dyes are longer wavelength dyes while simple cyanine dyes are typically yellow dyes, but can exhibit absorption maxima up to about 550 nm in wavelength with proper choice of nuclei and other components capable of bathochromically shifting absorption. Preferred polymethine dyes, particularly cyanine dyes, for use as fluorescent dyes are so-called rigidized dyes. These dyes are constructed to restrict the movement of one nucleus in relation to another. This avoids rddiationless, kinetic dissipation of the excited state energy. One approach to rigidizing the dye structure is to incorporate a separate bridging group providing a separate linkage in addition to the methine chain linkage joining the terminal nuclei of the dye. Bridged polymethine dyes are illustrated by Brooker et al U.S. Pat. No. 2,478,367, Brooker U.S. Pat. No. 2,479,152, Gilbert U.S. Pat. No. 4,490,463, and Tredwell et al, “Picosecond Time Resolved Fluorescence Lifetimes of the Polymethine and Related Dyes”, Chemical Physics, Vol. 43 (1979) pp. 307-316. The methine chain joining polymethine dye nuclei can be rigidized by including the methine chain as part of a cyclic nucleus joining the terminal basic nuclei of the dye. One of the techniques for both rigidizing and bathochromically shifting the absorption maxima of polymethine dyes in general and cyanine dyes in particular is to include in the methine linkage an oxocarbon bridging nucleus

Another useful class of fluorescent dyes are 4-oxo4H-benz-[d,e] anthracenes, hereinafter referred to as oxobenzanthracene dyes.

Dyes of this class and their preparations are disclosed in Goswami et al U.S. Ser. No. 824,765, filed Jan. 31, 1986, commonly assigned, titled Fluorescent Dyes and Biological and Analytical uses thereof.

The oxobenzanthracene dyes can be prepared by known methods e.g. (1) preparation of a dihydrophenalenone by the procedure described by Cooke et al, Australian J. Chem., 11, pp. 230-235 (1958), (2) preparation of the lithium enolate of the dihydrophenalenone, (3) reaction of the lithium enolate with the appropriate phosphonium iodide reagent, and (4) reaction of this product with cupric chloride and lithium chloride to produce the chlorinated or unchlorinated dye.

The oxobenzanthracene can have one or more substituents in the structure as long as the substituents do not adversely affect the fluorescence of the compound, such as alkyl (e.g., alkyl of 1 to 5 carbon atoms), aryl (e.g., phenyl), and other groups.

Another useful class of fluorescent dyes are xanthene dyes. One particularly preferred class of xanthene dyes are rhodamine dyes.

Another specifically preferred class of xanthene dyes are fluorescein dyes

Another useful group of fluorescent dyes are pyrylium, thiapyrylium, selenapyrylium, and telluropyrylium dyes. Dyes from the first three of these classes are disclosed by Light U.S. Pat. No. 3,615,414 while dyes of the latter class are disclosed by Detty U.S. Pat. No. 4,584,258, the disclosures of which are here incorporated by reference. Since the latter two classes of dyes are bathochromically shifted toward the infrared the former two classes of dyes are preferred for achieving visible light emissions.

Another useful class of fluorescent dyes are fluorescent carbostyril dyes. These dyes are characterized by a 2-quinolinol or isoquinolinol ring structure, often fused with other rings. The wavelength of maximum fluorescence generally increases with the presence of other fused rings.

Examples of more complex fused ring carbostyril dyes are provided by Kadhim and Peters, “New Intermediates and Dyes for Synthetic Polymer Fibres Substituted Benzimidazolothioxanthenoisoquinolines for Polyester Fibres”, JSDC, June 1974, pp. 199-201, and Arient et al, “Imidazole Dyes XX-Colouring Properties of 1,2-Napthooxylenebenzimidazole Derivatives”, JSDC, June 1968, pp. 246-251.

Among other fused ring fluorescent dyes the perylene dyes, characterized by a dinapthylene nucleus. A variety of useful fluorescent perylene dyes are known, such as, for example those disclosed by Rademacher et al, “Soluble Perylene Fluorescent Dyes with Photostability”, Chem. Ber. , Voi. 115, pp. 2927-2934, 1982, and European Patent Application No. 553,363A 1, published Jul. 7, 1982.

Many other classes of known fluorescent dyes, such as acridine dyes; bis(styryl)benzene dyes; pyrene dyes; oxazine dyes; and phenyleneoxide dyes, sometimes referred to as POPOP dyes; are useful.

Not only are there many available classes of fluorescent dyes to choose from, there are wide choices of individual dye properties within any given class. The absorption maxima and reduction potentials of individual dyes can be varied through the choice of substituents. As the conjugation forming the chromophore of the dye is increased the absorption maximum of a dye can be shifted bathochromically.

Emission maxima are bathochromic to the absorption maxima.

Although the degree of bathochromic shifting can vary as a function of the dye class, usually the wavelength of maximum emission is from 25 to 125 nm bathochromically shifted as compared to the wavelength of maximum absorption. Thus, dyes which exhibit absorption maxima in the near ultraviolet in almost all cases exhibit maximum emissions in the blue portion of the spectrum. Dyes which exhibit absorption maxima in the blue portion of the spectrum exhibit emission maxima in the green portion of the spectrum, and, similarly, dyes with absorption maxima in the red portion of the spectra tend to exhibit emission maxima in the near infrared portion

A further class of fluorescent compounds which can be used are fluorescent dyes having a chromophoric unit containing at least 5 fused carbocyclic aromatic rings (hereinafter referred to as a pentacarbocyclic aromatic fluorescent dye). Suitable dyes are described in U.S. Pat. Nos. 5,150,006 and 5,405,709.

These pentacarbocyclic aromatic fluorescent dyes have been discovered to be highly advantageous for reducing the wavelength of organic EL device emission. To function in a first category arrangement it is essential that the fluorescent dye absorb at a wavelength corresponding to an emission wavelength of the host compound. On the other hand, it is recognized that all fluorescent dyes emit at a longer wavelength than they absorb. Stated another way, a dye cannot emit light of a higher energy level than its absorbs. The difference between the longest wavelength absorption maxima (hereinafter referred to as the peak absorption) and the shortest wavelength emission maxima (hereinafter referred to as the peak emission) of a fluorescent dye is known as its Stokes shift. If the Stokes shift of a fluorescent dye is large, it is difficult to achieve efficient spectral coupling and still achieve peak emission at a shorter wavelength than that of the EL compound. Pentacarbocyclic aromatic fluorescent dyes are particularly suited for shifting organic EL device emissions to shorter blue wavelengths, since they exhibit Stokes shifts of from 80 nm to less than 20 nm, attributable to their relatively rigid chromophoric units. Thus, a hypsochromic shift in organic EL device emission can be realized even though the absorption peak of the pentacarbocyclic aromatic fluorescent dye is only 20 nm shorter in wavelength than the emission peak of the charge carrier compound. Preferred pentacarbocyclic aromatic fluorescent dyes are those that exhibit an absorption peak at wavelengths ranging from 100 to 20 nm shorter than the emission peak exhibited by the formula II charge carrier compound.

The pentacarbocyclic aromatic fluorescent dyes contemplated each contain at least 5 fuised carbocyclic aromatic rings, which form a cluromophoric unit. Fused aromatic carbocyclic rings in addition to the 5 required fused rings do not detract from performance characteristics. Preferred chromophoric units contain a perylene, benzopyrene, benzochrysene, benzonaphthacene, picene, pentaphene, pentacene, hexacene or anthanthrene nucleus, as the entire nucleus or fused with other aromatic rings to complete the nucleus. Typically these dyes contain from 20 to 40 ring carbon atoms.

These pentacarbocyclic aromatic rings have the advantage that they can be deposited by vacuum vapour deposition, similarly as the other components of the organic medium. Since the pentacarbocyclic aromatic rings represent chromophores in and of themselves, it is not necessary that other ring substituents be present. However, many dyes containing pentacarbocyclic aromatic rings as chromophores are conventional, having been originally prepared for use in solution chemistry and therefore having substituents intended to modify solubility and, in some instances, hue.

When fluorescent pentacarbocyclic aromatic dyes are incorporated in a host charge acceptor compound, only a small amount of the fluorescent dye is required to realize advantages. Fluorescent pentacarbocyclic aromatic dyes are preferably incorporated in a concentration ranging from 0.05 to 5 mole percent, based on the moles of charge accepting compound. A specifically preferred concentration range is from 0.2 to 3 mole percent, based on the moles of charge accepting compound, with a concentration range of from 0.5 to 2 mole percent, based on the moles of charge accepting compound, being in most instances optimum.

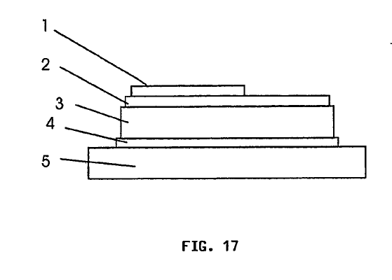

A device according to one embodiment of the invention is shown in FIG. 17 the accompanying drawing which shows schematically a structure of the invention and in which there is a aluminium cathode (1), on which there is a layer of a electron transporting material (2), a layer of a rare earth chelate electroluminescent material incorporating a fluorescent dye (3), a layer of a hole transmitting material (4) and an anode which is a transparent ITO layer (5). When an electric field is applied between the substrate and the ITO light is emitted via (5).

1-28. (canceled)

29. An organic electroluminescent device comprising in sequence, an anode, a layer of an electroluminescent material, and a cathode, in which the electroluminescent material is selected from compounds of the general chemical formula 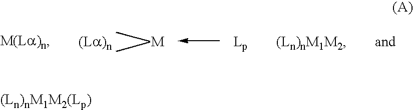
where Lα is selected from organic ligands and from compounds of formula: 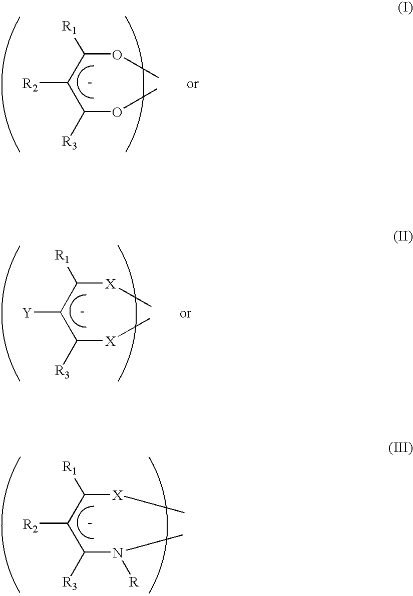
where R₁, R₂ and R₃ can be the same or different and are selected from hydrogen, and substituted and unsubstituted hydrocarbyl groups, substituted and unsubstituted aliphatic groups, substituted and unsubstituted aromatic, heterocyclic and polycyclic ring structures, fluorocarbons, trifluoryl methyl groups, halogens and thiophenyl groups; R₁, R₂ and R₃ can also form substituted and unsubstituted fused aromatic, heterocyclic and polycyclic ring structures and can be copolymerisable with a monomer; X is Se, S or O; Y is selected from hydrogen, substituted or unsubstituted hydrocarbyl groups, substituted and unsubstituted aromatic, heterocyclic and polycyclic ring structures, fluorine, fluorocarbons such as trifluoryl methyl groups, halogens, thiophenyl groups and nitrile and the ligands Lf and Lα are the same or different;
Lp is a neutral organic ligand, or is of formula 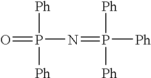
where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group;
M and M₁ are a rare earth, transition metal, lanthanide or an actinide, M₂ is a non rare earth rare earth, transition metal, lanthanide or an actinide metal and n is the combined valence state of M, M₁ and M₂ or from compounds of the general chemical formula 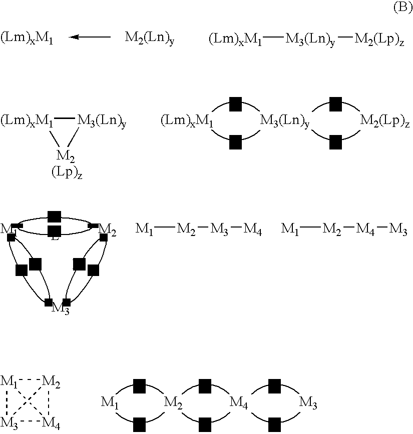
where L is a bridging ligand and where M₁ and M₃ are selected from a rare earth, transition metal, lanthanide or an actinide, M₂ is a non rare earth metals and M₄ is M₁;
Lm, Lp and Ln are the same or different organic ligands or are Lα, as defmned above, x is the valence state of M₁, y is the valence state of M₂, and z is the valence state of M₃ and in which the rare earth metals and the non rare earth metals can be joined together by a metal to metal bond and/or via an intermediate bridging atom, ligand or molecular group or in which there are more than three metals joined by metal to metal bonds and/or via intermediate ligands and there is located in the electroluminescent layer as a fluorescent material a dye capable of emitting light in response to hole-electron recombination.

30. An electroluminescent device according to claim 29 in which M₂ is selected from lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states, manganese, iron, ruthenium, osmium, cobalt, nickel, palladium(II), palladium(IV), platinum(II), platinum(IV), cadmium, chromium. titanium, vanadium, zirconium, tantulum, molybdenum, rhodium, iridium, titanium, niobium, scandium and yttrium.

31. An electroluminescent device according to claim 29 in which there is an organic hole transporting material in contact with or mixed with the layer of the electroluminescent material.

32. An electroluminescent device according to claim 31 in which the hole transmitting material is a film of a polymer selected from poly(vinylcarbazole), N,N′-diphenyl-N,N′-bis(3-methylphenyl)-1,1′-biphenyl-4,4′-diamine(TPD), polyaniline, substituted polyanilines, polythiophenes, substituted polythiophenes, polysilanes, substituted polysilanes, compounds of formula 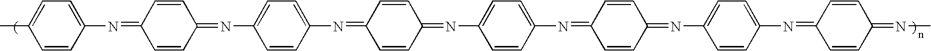
where n is from 1 to 20.

33. An electroluminescent device according to claim 29 in which there is a layer of an electron transmitting material between the cathode and the electroluminescent material layer or mixed with the electroluminescent material.

34. An electroluminescent device according to claim 33 in which the electron transmitting material is a metal quinolate, an aluminium quinolate or lithium quinolate, cyanoanthracenes such as 9,10 dicyanoanthracenes, polystyrene sulphonates.

35. An electroluminescent device according to claim 29 in which the cathode is selected from aluminium, calcium, lithium, silver/magnesium alloys.

36. An electroluminescent device according to claim 31 in which the cathode is selected from aluminium, calcium, lithium, silver/magnesium alloys.

37. An electroluminescent device according to claim 34 in which the cathode is selected from aluminium, calcium, lithium, silver/magnesium alloys.

38. An electroluminescent device according to claim 29 in which the fluorescent material is a dye which has a bandgap no greater than that of the electroluminescent material and a reduction potential less negative than that of the electroluminescent material.

39. An electroluminescent device according to claim 29 in which the electroluminescent material is capable of emitting light of a first wavelength in the absence of said fluorescent material and said fluorescent material is capable of absorbing light at the first wavelength.

40. An electroluminescent device according to claim 38 in which the fluorescent material is a blue emitting dye.

41. An electroluminescent device according to claim 38 in which the fluorescent material is a dye which exhibits a shorter wavelength emission peak than the electroluminescent material.

42. An electroluminescent device according to claim 29 in which the fluorescent material is a dye which is present in the layer of the electroluminescent material in a concentration ranging from about 0.05 to 5 mole percent.

43. An electroluminescent device according to claim 38 in which the fluorescent material is a dye which is present in the layer of the electroluminescent material in a concentration ranging from about 0.05 to 5 mole percent.

44. An organic electroluminescent device comprising in sequence, an anode, a layer of a hole transporting material, a layer of an electroluminescent material, a layer of an electron transmitting material, and a cathode, in which the electroluminescent material is selected from compounds of the general chemical formula 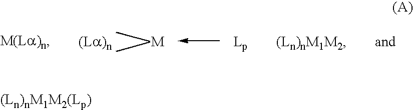
where Lα is selected from organic ligands and from compounds of formula:— 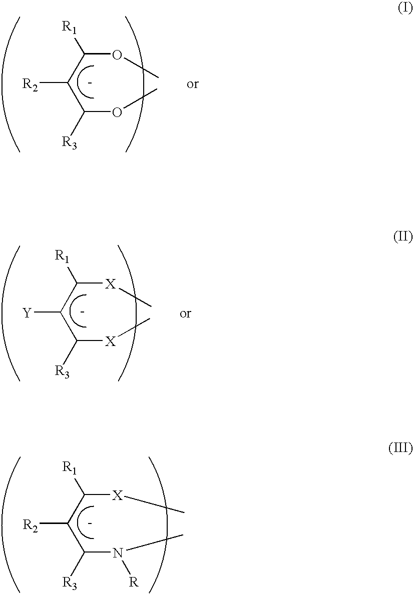
where R₁, R₂ and R₃ can be the same or different and are selected from hydrogen, and substituted and unsubstituted hydrocarbyl groups, substituted and unsubstituted aliphatic groups, substituted and unsubstituted aromatic, heterocyclic and polycyclic ring structures, fluorocarbons, trifluoryl methyl groups, halogens and thiophenyl groups; R₁, R₂ and R₃ can also form substituted and unsubstituted fused aromatic, heterocyclic and polycyclic ring structures and can be copolymerisable with a monomer; X is Se, S or O; Y is selected from hydrogen, substituted or unsubstituted hydrocarbyl groups, substituted and unsubstituted aromatic, heterocyclic and polycyclic ring structures, fluorine, fluorocarbons such as trifluoryl methyl groups, halogens, thiophenyl groups and nitrile and the ligands Ln and Lα are the same or different;
Lp is a neutral organic ligand, or is of formula 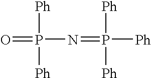
where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group;
M and M₁ are a rare earth, transition metal, lanthanide or an actinide, M₂ is a non rare earth rare earth, transition metal, lanthanide or an actinide metal and n is the combined valence state of M, M₁ and M₂ or from compounds of the general chemical formula 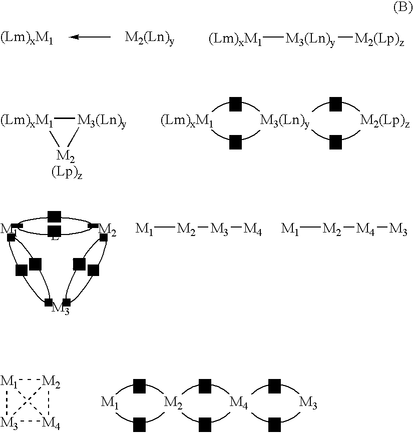
where L is a bridging ligand and where M₁ and M₃ are selected from a rare earth, transition metal, lanthanide or an actinide, M₂ is a non rare earth metals and M₄ is M₁;
Lm, Lp and Ln are the same or different organic ligands or are Lα, as defined above, x is the valence state of M₁, y is the valence state of M₂, and z is the valence state of M₃ and in which the rare earth metals and the non rare earth metals can be joined together by a metal to metal bond and/or via an intermediate bridging atom, ligand or molecular group or in which there are more than three metals joined by metal to metal bonds and/or via intermediate ligands and there is located in the electroluminescent layer as a fluorescent material a dye capable of emitting light in response to hole-electron recombination.

45. An electroluminescent device according to claim 44 in which the fluorescent material is a dye which is selected from the group consisting of coumarin, dicyanomethylenepyrans and thiopyrans, polymethine, oxabenzanthracene, xanthene, pyrylium and thiapyrylium, carbostyril, and perylene fluorescent dyes.

46. An electroluminescent device according to claim 44 in which the electroluminescent material is capable of emitting light of a first wavelength in the absence of said fluorescent material and said fluorescent material is capable of absorbing light at the first wavelength.

47. An electroluminescent device according to claim 46 in which the fluorescent material is a dye which is a blue emitting dye.

48. An electroluminescent device according to claim 44 in which the fluorescent material is a dye which exhibits a shorter wavelength emission peak than the electroluminescent material.

49. An electroluminescent device according to claim 44 in which the fluorescent material is a dye which is present in the layer of the electroluminescent material in a concentration ranging from about 0.05 to 5 mole percent.
